(19) United States
(12) Patent Application Publication
(10) Pub. No.: US 2025/0118056 A1
(43) Pub. Date: Apr. 10, 2025

(54) NEURAL DATASETS FOR MEDICAL IMAGES

(71) Applicant: Elekta Limited, Crawley (GB)

(72) Inventors: Samuele PAPA, Crawley (GB); Riccardo VALPERGA, Crawley (GB); Jan-Jakob Sonke, Amsterdam (NL); Efstratios GAVVES, Crawley (GB); David KNIGGE, Crawley (GB)

(21) Appl. No.: 18/911,749

(22) Filed: Oct. 10, 2024

(30) Foreign Application Priority Data
Oct. 10, 2023 (GB) 2315509.6

(51) Int. Cl. G06V 10/774; G06V 10/82

(52) U.S. Cl. CPC G06V 10/774; G06V 10/82; G06V 2201/03

(57) ABSTRACT

A computer-implemented method for generating a neural dataset of medical images for use in a Machine Learning (ML) task. The method comprises obtaining a dataset of medical images, a neural field, and seeds for initiating the neural field. A size of a first subset for the neural dataset is obtained, smaller than a total potential neural dataset comprising one or more Implicit Neural Representations (INRs) generated from the neural field initiated with each seed for each medical image. Additional INRs are generated for the first subset by fitting the neural field, initiated with a seed, to a medical image. The INRs in the first subset are output as the neural dataset. Generating INRs for the first subset involves parallel generation of multiple INRs of the first subset on a single processing apparatus.

### Claim for Priority

This application claims the benefit of priority to British Application No. 2315509.6, filed Oct. 10, 2023, which is incorporated by reference in its entirety.

### TECHNICAL FIELD

The present disclosure relates to a computer implemented method for generating a Neural Dataset of medical images, wherein the Neural Dataset is for use in a Machine Learning task. The present disclosure also relates to a processing node, and to a computer program product configured, when run on a computer, to carry out methods for generating a Neural Dataset of medical images.

### BACKGROUND

Implicit Neural Representations (INR) have emerged as an alternative to traditional array representations of data. For example, color images are commonly processed as grids of RGB pixel intensities, and 3D shapes are commonly processed as voxel occupancies. In contrast to this traditional approach, INRs are functions that map, in the case of color images, coordinates to RGB values. In this manner, an INR respects the continuous nature of the underlying signal to be represented, as opposed to discretizing, via a grid, what is often a continuous underlying signal.

In general, INRs can be used with a range of data modalities, in particular, they have gained traction in computer vision to represent not only images [1, 2, 3], but also videos [4], 3D shapes and scenes [5, 6, 7, 8], medical images [9, 10] and audio [2, 11]. The benefits of such functional representations include the ability to process the data at an arbitrary resolution, and to deal with data that is difficult to discretize such as signals that are sampled irregularly on grids with inconsistent shapes across the dataset. Even signals on non-Euclidean manifolds, such as complex PDE solutions and climate data, can be handled more naturally with INRs. Furthermore, INRs allow for more memory/compute efficient training for downstream tasks since ideally, the dimension of the INR can be significantly lower than that of the array representing the signal.

Considering the example of medical images specifically, Computed Tomography (CT) is a medical imaging technique for reconstructing material density inside a patient, using the mathematical and physical properties of X-ray scanners. In CT, several X-ray scans, or projections, of the patient are acquired from various angles using a detector, and reconstruction methods are then used to create a three-dimensional image of the patient volume from the two dimensional measurement data in the projections. An important variant of CT is Cone Beam CT (CBCT), which uses flat panel detectors to scan a large fraction of the volume in a single rotation. CBCT reconstruction is more difficult than reconstruction for classical (helical) CT, owing to the inherent mathematical difficulty of Radon Transform inversion in the three-dimensional setting, physical limits of the detector, and characteristics of the measurement process such as noise.

INRs may offer particular advantages for the representation of medical images such as CT and CBCT images, owing to their ability to process data at an arbitrary resolution. For example, CT scans may result in different resolutions across different axes. In a conventional setting, this may be addressed by interpolating between slices for the axes with the lower resolution. However, with an INR that can be sampled an any resolution, this issue is completely avoided.

Motivated by the advantages offered by INRs, recent works have shown promising results in performing deep learning tasks, such as classification and generation, directly on implicit representations [12, 13, 14]. However, this new paradigm shift comes with significant challenges. Before any downstream ML tasks can be contemplated, existing datasets, which may be extremely large, have to be converted into datasets of INRs. This conversion requires training small neural networks to fit each of the signals to be represented, a new neural network being trained for each data sample from scratch. If not done efficiently this operation can become prohibitively expensive for large datasets. [12] seek to address this issue by using modulation and by meta-learning initial conditions that allow INRs to be fitted in a few gradient descent steps, however this method still requires significant time and processing resources. In addition, the impact of the hyperparameters of the Neural Field form which the INR is generated on INR quality as downstream representation is not well understood and remains largely unexplored. With current limited understanding of how neural networks behave as a function of their architecture and optimization, and the difficulties in generating INR datasets, identifying what makes the parameters of a Neural Field a good representation for downstream tasks remains an open challenge.

### Background References

[1] Kenneth O Stanley. Compositional pattern producing networks: A novel abstraction of development. Genetic programming and evolvable machines, 8:131-162, 2007.

[2] Vincent Sitzmann, Julien Martel, Alexander Bergman, David Lindell, and Gordon Wetzstein. Implicit neural representations with periodic activation functions. Advances in neural information processing systems, 33:7462-7473, 2020.

[3] Matthew Tancik, Pratul Srinivasan, Ben Mildenhall, Sara Fridovich-Keil, Nithin Raghavan, Utkarsh Singhal, Ravi Ramamoorthi, Jonathan Barron, and Ren Ng. Fourier features let networks learn high frequency functions in low dimensional domains. Advances in Neural Information Processing Systems, 33:7537-7547, 2020.

[4] Keunhong Park, Utkarsh Sinha, Jonathan T Barron, Sofien Bouaziz, Dan B Goldman, Steven M Seitz, and Ricardo Martin-Brualla. Nerfies: Deformable neural radiance fields. In Proceedings of the IEEE/CVF International Conference on Computer Vision, pages 5865-5874, 2021.

[5] Lars Mescheder, Michael Oechsle, Michael Niemeyer, Sebastian Nowozin, and Andreas Geiger. Occupancy networks: Learning 3d reconstruction in function space. In Proceedings of the IEEE/CVF conference on computer vision and pattern recognition, pages 4460-4470, 2019.

[6] Jeong Joon Park, Peter Florence, Julian Straub, Richard Newcombe, and Steven Lovegrove. Deepsdf: Learning continuous signed distance functions for shape representation. In Proceedings of the IEEE/CVF conference on computer vision and pattern recognition, pages 165-174, 2019.

[7] Ben Mildenhall, Pratul P Srinivasan, Matthew Tancik, Jonathan T Barron, Ravi Ramamoorthi, and Ren Ng. Nerf: Representing scenes as neural radiance fields for view synthesis. Communications of the ACM, 65 (1): 99-106, 2021.

[8] Alex Yu, Vickie Ye, Matthew Tancik, and Angjoo Kanazawa. pixelnerf: Neural radiance fields from one or few images. In Proceedings of the IEEE/CVF Conference on Computer Vision and Pattern Recognition, pages 4578-4587, 2021.

[9] Ruyi Zha, Yanhao Zhang, and Hongdong Li. Naf: neural attenuation fields for sparse-view cbct reconstruction. In International Conference on Medical Image Computing and Computer-Assisted Intervention, pages 442-452. Springer, 2022.

[10] Samuele Papa, David M Knigge, Riccardo Valperga, Nikita Moriakov, Miltos Kofinas, Jan-Jakob Sonke, and Efstratios Gavves. Neural modulation fields for conditional cone beam neural tomography. arXiv preprint arXiv: 2307.08351, 2023.

[11] Ruohan Gao, Yen-Yu Chang, Shivani Mall, Li Fei-Fei, and Jiajun Wu. Objectfolder: A dataset of objects with implicit visual, auditory, and tactile representations. arXiv preprint arXiv: 2109.07991, 2021.

[12] Emilien Dupont, Hyunjik Kim, S M Eslami, Danilo Rezende, and Dan Rosenbaum. From data to functa: Your data point is a function and you can treat it like one. arXiv preprint arXiv: 2201.12204, 2022.

[13] Dejia Xu, Peihao Wang, Yifan Jiang, Zhiwen Fan, and Zhangyang Wang. Signal processing for implicit neural representations. Advances in Neural Information Processing Systems, 35:13404-13418, 2022.

[14] Matthias Bauer, Emilien Dupont, Andy Brock, Dan Rosenbaum, Jonathan Schwarz, and Hyunjik Kim. Spatial functa: Scaling functa to imagenet classification and generation. arXiv preprint arXiv: 2302.03130, 2023.

[15] Thomas Unterthiner, Daniel Keysers, Sylvain Gelly, Olivier Bousquet, and Ilya Tolstikhin. Predicting neural network accuracy from weights. arXiv preprint arXiv: 2002.11448, 2020.

[16] Gabriel Eilertsen, Daniel Jönsson, Timo Ropinski, Jonas Unger, and Anders Ynnerman. Classifying the classifier: dissecting the weight space of neural networks. arXiv preprint arXiv: 2002.05688, 2020.

[17] Aviv Navon, Aviv Shamsian, Idan Achituve, Ethan Fetaya, Gal Chechik, and Haggai Maron. Equivariant architectures for learning in deep weight spaces. arXiv preprint arXiv: 2301.12780, 2023.

[18] David W Zhang, Miltiadis Kofinas, Yan Zhang, Yunlu Chen, Gertjan J Burghouts, and Cees GM Snoek. Neural networks are graphs! graph neural networks for equivariant processing of neural networks. 2023.

### SUMMARY

It is an aim of the present disclosure to provide a method, a processing node, and a computer program product which at least partially address one or more of the challenges mentioned above. It is a further aim of the present disclosure to provide a method, a processing node, and a computer program product which cooperate to enable fast and efficient generation of Neural Datasets of medical images for use in a Machine Learning task.

According to a first aspect of the present disclosure, there is provided a computer implemented method for generating a Neural Dataset of medical images, wherein the Neural Dataset is for use in a Machine Learning (ML) task, and wherein the Neural Dataset comprises a plurality of Implicit Neural Representations (INRs) each INR representing a medical image. The method comprises obtaining: a dataset of medical images, a Neural Field, and a plurality of seeds for initiating the Neural Field. The method further comprises obtaining a size of a first subset for the Neural Dataset, wherein the size is smaller than the total potential Neural Dataset, and wherein the total potential Neural Dataset comprises, for each medical image of the dataset, an INR generated from the Neural Field initiated with each of the plurality of seeds. The method further comprises generating INRs for the first subset by, for each INR of the first subset, fitting the Neural Field, initiated with one of the plurality of seeds, to a medical image in the dataset, and outputting the INRs comprised in the first subset as the Neural Dataset. According to the method, generating INRs for the first subset comprises generating a plurality of INRs of the first subset in parallel on a single processing apparatus.

According to another aspect of the present disclosure, there is provided a computer implemented method for training a ML model for use in a ML task, the method comprising using, as training data for the ML model, a Neural Dataset of medical images, wherein the Neural Dataset has been generated using a method according to any one of the examples or aspects described herein.

According to another aspect of the present disclosure, there is provided a computer implemented method for performing a ML task using a trained ML model, the method comprising inputting, to the ML model, a Neural Dataset of medical images, wherein the Neural Dataset has been generated using a method according to any one of the examples or aspects described herein.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more aspects or examples of the present disclosure.

According to another aspect of the present disclosure, there is provided a processing node for generating a Neural Dataset of medical images, wherein the Neural Dataset is for use in a ML task, and wherein the Neural Dataset comprises a plurality of INRs, each INR representing a medical image. The processing node comprises processing circuitry configured to cause the processing node to obtain: a dataset of medical images, a Neural Field, and a plurality of seeds for initiating the Neural Field. The processing circuitry is further configured to cause the processing node to obtain a size of a first subset for the Neural Dataset, wherein the size is smaller than the total potential Neural Dataset, and wherein the total potential Neural Dataset comprises, for each medical image of the dataset, an INR generated from the Neural Field initiated with each of the plurality of seeds. The processing circuitry is further configured to cause the processing node to generate INRs for the first subset by, for each INR of the first subset, fitting the Neural Field, initiated with one of the plurality of seeds, to a medical image in the dataset, and output the INRs comprised in the first subset as the Neural Dataset. Generating INRs for the first subset comprises generating a plurality of INRs of the first subset in parallel on a single processing apparatus.

According to another aspect of the present disclosure, there is provided radiotherapy treatment apparatus comprising a processing node according to any one of the aspects or examples of the present disclosure.

Aspects and examples of the present disclosure thus provide methods that enable fast generation and manipulation of Neural Datasets for medical images. The speed gain in fitting Neural Datasets is substantial compared to known approaches, enabling the use of neural fields for representing datasets at scale.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. For a better understanding of the present disclosure, and to show more clearly how it may be carried into effect, reference will now be made, by way of example, to the following drawings in which:

FIG. 1 is a flow chart illustrating process steps in a method for generating a Neural Dataset of medical images, according to an example of the present disclosure.

FIG. 2 is a block diagram illustrating functional units in a processing node according to an example of the present disclosure.

FIG. 3 is a flow chart illustrating an example pipeline implementing methods according to an example of the present disclosure.

### DETAILED DESCRIPTION

Examples of the present disclosure present methods and nodes that offer efficient and parallelized training of implicit neural representations for any given dataset.

In order to provide additional context for the present disclosure, there now follows a brief discussion of Implicit Neural representations. INRs, also known as neural fields, NFs, are a class of neural architectures that parameterize a field ƒ: [symbol] ^{d} > [symbol] ⁿ, i.e., a quantity defined over spatial and/or temporal coordinates, using a neural network ƒ_{θ}(see Xie et al. (2022) for a survey on NFs). INRs are therefore functions ƒ_{θ}: [symbol] > [symbol] ⁿ mapping coordinates x∈ [symbol] features ƒ(x)∈ [symbol] ⁿ that are fit to a signal I minimizing a reconstruction loss:

$$ℒ ( θ ) = {\sum }_{i}^{N} {‖ {f}_{θ} ( {x}_{i} ) - I ( {x}_{i} ) ‖}^{2}$$

Where I(xᵢ) are the features of the signal at the location xᵢ. For example, for an RGB image, x, ∈ [symbol] are locations on a 2D grid and ƒ(xᵢ)∈ [symbol] ³ are RGB values.

A number of works have explored deep learning on weight spaces [15, 16, 17, 18], and deep learning on neural fields specifically. A challenge currently faced when performing research in this area is the lack of a consistent benchmarking regime across these different approaches. Different authors use different optimization schedules, architectures and datasets to fit their respective neural fields. Examples of the present disclosure provide a consistent framework for converting signal datasets to a dataset of neural fields, referred to in the present disclosure as a Neural Dataset. The methods presented herein are suitable for use with medical datasets, but may also be used for other datasets such as CIFAR10, CelebA and ShapeNet. The framework offered by the methods proposed herein ensures efficient conversion of a dataset to a neural dataset, improving evaluation and transferability of proposed approaches to weight space learning.

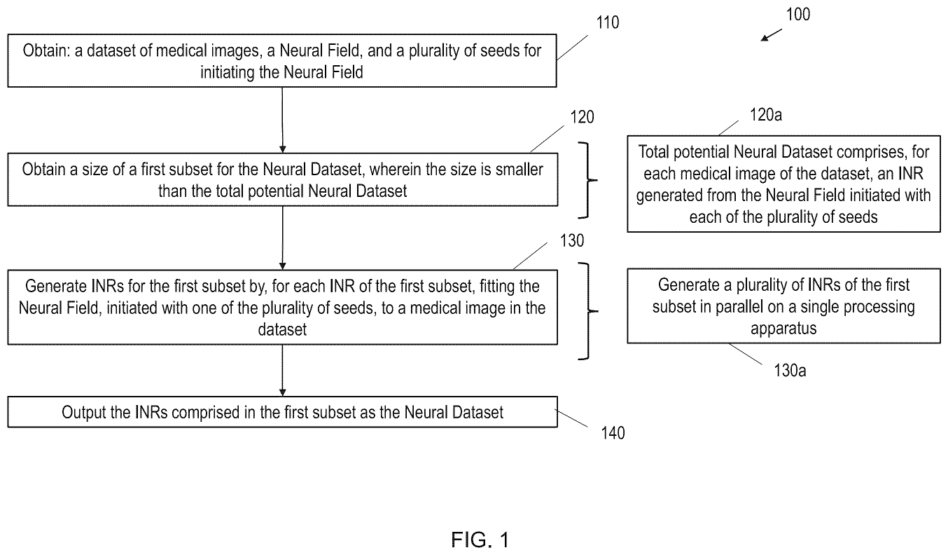

With reference to FIG. 1, a first example method 100 is presented for generating a Neural Dataset of medical images, wherein the Neural Dataset is for use in a Machine Learning (ML) task, and wherein the Neural Dataset comprises a plurality of Implicit Neural Representations, (INRs) each INR representing a medical image. The method may be performed by a processing node, which may comprise a physical or virtual node, and may be implemented in a computer system, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualized function, or any other logical entity. The processing node may encompass multiple logical entities, as discussed in greater detail below.

In a first step 110, the method comprises obtaining: a dataset of medical images, a Neural Field, and a plurality of seeds for initiating the Neural Field. The method then comprises, in step 120, obtaining a size of a first subset for the Neural Dataset, wherein the size is smaller than the total potential Neural Dataset. As illustrated at 120a, the total potential Neural Dataset comprises, for each medical image of the dataset, an INR generated from the Neural Field initiated with each of the plurality of seeds. The method then comprises, in step 130, generating INRs for the first subset by, for each INR of the first subset, fitting the Neural Field, initiated with one of the plurality of seeds, to a medical image in the dataset. In step 140, the method comprises outputting the INRs comprised in the first subset as the Neural Dataset. According to the method, as illustrated at 130a, generating INRs for the first subset comprises generating a plurality of INRs of the first subset in parallel on a single processing apparatus.

The disclosed method offers an efficient process for generating a Neural Dataset from a dataset of medical images, which Neural Dataset will be appropriate for use in a downstream ML tasks. It will be appreciated that the method involves outputting as the Neural Dataset a plurality of INRs that represents a subset of the total possible INRs that could be included in the Neural Dataset. The number of total possible INRs comprise the number of medical images multiplied by the number of seeds, on the basis that the total possible size of the Neural Dataset would be achieved by representing each image in the dataset with a plurality of Neural Fields, each Neural Field initialized with a different one of the plurality of seeds. It will be appreciated that a single image from the data set may be correctly represented by a plurality of different Neural Fields, the Neural Fields differing in their specific weights and biases but each, when sampled, providing a functional representation of the image. The different weights and biases may be arrived at during training as a consequence of different seeds selected to initialize the Neural Field. By obtaining a plurality of seeds, and then outputting as the Neural Dataset a subset of the total possible INRs that may be generated to represent the images based on those seeds, examples of the methods disclosed herein ensure certain level of variation in the Neural Dataset, and avoid a Neural Dataset that is particularly representative of any one possible set of initializing values for the Neural Fields used to represent the images. The resulting Neural Dataset is thus optimized for use in a downstream ML task.

In will further be appreciated that using a subset of the total possible number of INRs that could be included in the Neural Dataset, the methods disclosed herein avoid the generation of an excessively large dataset that would be both unwieldy and highly computationally expensive to use.

As discussed above, an INR or Neural Field, is a neural architecture that parameterizes a field, i.e., a quantity defined over spatial and/or temporal coordinates, using a neural network. An INR may thus comprise, for example, the values of trained parameters of the neural network that parameterizes the field, including for example the weights and biases of the neural network. A neural network is an example of a Machine Learning (ML) model. For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

Another example method is presented for generating a Neural Dataset of medical images, wherein the Neural Dataset is for use in a Machine Learning (ML) task, and wherein the Neural Dataset comprises a plurality of Implicit Neural Representations, (INRs) each INR representing a medical image. As for the method presented above, the method presented below may be performed by a processing node, which may comprise a physical or virtual node, and may be implemented in a computer system, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualized function, or any other logical entity. The processing node may encompass multiple logical entities, as discussed in greater detail below. The method presented below illustrates an example of how the method 100 presented above may be implemented and supplemented to achieve the above discussed and additional functionality.

In a first step, the method comprises obtaining: a dataset of medical images, a Neural Field, and a plurality of seeds for initiating the Neural Field. In some examples, obtaining may comprise receiving as input from a user.

The dataset of medical images may for example comprise a dataset of CT, CBCT, MRI, or other medical images. In some examples, the medical images may be reconstructed images. In other examples the images may comprise projection data from which a three-dimensional image may be reconstructed. The dataset of medical images may be input by a user, retrieved or downloaded from a memory or other storage area, or may be obtained in any other suitable manner.

In some examples, obtaining the Neural Field, and the plurality of seeds for initiating the Neural Field, may comprise receiving inputs form a user identifying the Neural Field, and indicating a number of seeds that are to be used for initializing the neural field. In some examples, obtaining the Neural Field may comprise obtaining values for hyperparameters describing the structure and training of the Neural Field. Such hyperparameters may be obtained from a memory, for example following an input form a user identifying the Neural Field. The hyperparameters comprise one or more of: parameterization, network depth, network width, learning rate, weight decay, activation function, and/or initialization method. The plurality of seeds for initiating the Neural Field may comprise random initializations of trainable parameters of the Neural Field. Obtaining the Neural Field may further comprise obtaining a target reconstruction accuracy.

The method then comprises obtaining a size of a first subset for the Neural Dataset. The size is smaller than the total potential Neural Dataset, wherein the total potential Neural Dataset comprises, for each medical image of the dataset, an INR generated from the Neural Field initiated with each of the plurality of seeds. The size of the total potential Neural Dataset therefore comprises the number of medical images in the dataset multiplied by the number of seeds. In some examples, obtaining a size of a first subset for the Neural Dataset may comprise obtaining index entries for the beginning and end of the first subset.

The method then comprises generating INRs for the first subset by, for each INR of the first subset, fitting the Neural Field, initiated with one of the plurality of seeds, to a medical image in the dataset. According to the method, this step of generating INRs for the first subset comprises generating a plurality of INRs of the first subset in parallel on a single processing apparatus.

According to examples of the method, for each INR of the first subset, fitting the Neural Field, initiated with one of the plurality of seeds, to a medical image in the dataset may comprise minimizing a loss function between an output of the Neural Field and the medical image. In some examples, the medical images may comprise two dimensional images, and the loss function may comprise a Mean Squared Error loss. In further examples, the medical images may comprise three dimensional images, and the loss function may comprise at least one of Mean Squared Error loss, Absolute Error loss, Cross Entropy loss, Binary Cross Entropy loss. Other losses could be used, on condition that the loss is applied independently to the whole medical image.

As discussed above, generating INRs for the first subset comprises generating a plurality of INRs of the first subset in parallel on a single processing apparatus. The processing apparatus may for example comprise a Graphics Processing Unit (GPU). In some examples, the method may further comprise obtaining a number of INRs of the first subset to be generated in parallel on the single processing apparatus. The number of INRs to be generate din parallel may for example be obtained by being input by a user.

In some examples, the method then comprises outputting the INRs comprised in the first subset as the Neural Dataset.

In other examples, the method may further composite generating INRs for one or more second subsets of the Neural Dataset by, for each INR of the one or more second subsets, fitting the Neural Field, initiated with one of the plurality of seeds, to a medical image in the dataset. The method may then comprise outputting the INRs contained in the first subset and the INRs contained in the one or more second subsets as the Neural Dataset. In some examples, generating INRs for the one or more second subsets of the

Neural Dataset may comprise generating a plurality of INRs of the one or more second subsets in parallel on a single processing apparatus. In further examples, the method may comprise generating INRs for the one or more second subsets and generating the INRs for the first subset in parallel across a plurality of processing apparatuses. The plurality of processing apparatuses may include multiple different devices of the same logical entity, and/or multiple different logical entities. In this manner, not only is generation of INRs for each individual subset performed in parallel on individual processing apparatuses, but the generation of the subsets themselves may also take advantage of parallel processing. For example, in an apparatus comprising two GPUs, a first subset may be generated using parallel processing on the first GPU, and a second subset may, at the same time, be generated using parallel processing on the second GPU.

According to examples of the present disclosure, the ML task for which the Neural Dataset is used may comprise at least one of: a modeling task, a generative modeling task, a classification task, a regression task, a clustering task, an anomaly detection task, a segmentation task and/or an object detection task. In some examples, the Neural Dataset may be for use in a plurality of ML tasks, including any combination of the above noted tasks. The Neural Dataset may be for use in at least one of training, testing, or validating a ML model for an ML task, and/or inputting to an ML model that has been trained to perform an ML task.

In some examples, the method may further comprise generating a second Neural Dataset of the medical images. This may include generating INRs for a first subset of the second Neural Dataset, the first subset of the second Neural Dataset being of the same size as the first subset of the original Neural Dataset, and outputting the INRs comprised in the first subset of the second Neural Dataset as the second Neural Dataset.

As for the first Neural Dataset, generating INRs for the first subset of the second Neural Dataset may comprise, for each INR of the first subset of the second Neural Dataset, fitting the Neural Field, initiated with one of the plurality of seeds, to a medical image in the dataset, and generating a plurality of INRs of the first subset of the second Neural Dataset in parallel on a single processing apparatus. In some examples, a value of a hyperparameter of the Neural Field fitted to medical images for the first subset of the second Neural Dataset may be different to the value of that hyperparameter of the Neural Field fitted to medical images of the first subset for the original Neural Dataset. In this manner, the impact of changing one or more hyperparameters of the Neural Field used to generated the INRs of the Neural Dataset may be investigated, either by examining the first and second Neural Datasets themselves, or through experimentation with downstream ML tasks.

According to further examples of the present disclosure, there is also presented a computer implemented method for training an ML model for use in a ML task, the method comprising using, as training data for the ML model, a Neural Dataset of medical images, wherein the Neural Dataset has been generated using methods according to the present disclosure.

According to further examples of the present disclosure, there is also presented a computer implemented method for performing an ML task using a trained ML model, the method comprising inputting, to the ML model, a Neural Dataset of medical images, wherein the Neural Dataset has been generated using methods according to the present disclosure.

The present disclosure also provides a computer program product comprising a computer readable medium, the computer readable medium having computer readable code embodied therein, the computer readable code being configured such that, on execution by a suitable computer or processor, the computer or processor is caused to perform a method according to the present disclosure.

Examples of the present disclosure enable the efficient generation of Neural Datasets of medical images. |Such medical images may for example comprise CT or CBCT images. An important use for CBCT is in the planning and delivery of Radiotherapy, which may be used to treat cancers or other conditions in human or animal tissue. The treatment planning procedure for radiotherapy may include using a three dimensional image of the patient to identify a target region, for example the tumour, and to identify organs near the tumour, termed Organs at Risk (OARs). A treatment plan aims to ensure delivery of a required dose of radiation to the tumour, while minimizing the risk to nearby OARs. A treatment plan for a patient may be generated in an offline manner, using medical images that have been obtained using, for example classical CT. These images are generally referred to in this context as diagnostic or planning CT images. The radiation treatment plan includes parameters specifying the direction, cross sectional shape, and intensity of each radiation beam to be applied to the patient. The radiation treatment plan may include dose fractioning, in which a sequence of radiation treatments is provided over a predetermined period of time, with each treatment delivering a specified fraction of the total prescribed dose. Multiple patient images may be required during the course of radiotherapy treatment, and owing to their speed, convenience, and lower cost, CBCT images, as opposed to classical CT images, may be used to determine changes in patient anatomy between delivery of individual dose fractions.

Analysis of CT and CBCT images for the development and delivery of a radiotherapy treatment plan has been enhanced with Machine Learning, with the aim of improving accuracy and repeatability, and reducing the clinician time required for this process. Analysis tasks for which ML techniques have been explored include image reconstruction, scatter, noise and artifact reduction, image segmentation, etc. Performing such ML tasks on Neural Datasets generated according to the present disclosure, as opposed to standard arrays representing the CT or CBCT scans, can offer particular advantages, as discussed below.

According to existing techniques for performing ML tasks on CT or CBCT images, it is first necessary to use traditional reconstruction methods in order to generate reconstructed images from the measurement data captured in the 2D projections of a patient. These reconstructed images are then used as input to the ML model for performing the downstream ML task, such as segmentation of a target tumor and nearby organs at risk. Traditional reconstruction methods address the inverse problem of obtaining a reconstructed patient volume from the measured intensity values present in projection data. In contrast, when fitting an INR to a medical image, the process of fitting the INR effectively models the data acquisition process, i.e., the INR models the process by which X-rays are attenuated by the patient volume, with this modeling being supervised by the obtained measurements. Medical images encoded with INRs ae thus inherently more explicitly representative of the underlying patent volume than arrays representing a reconstructed image. It may consequently be inferred that downstream ML tasks performed on the more explicit representation of the patient volume that is provided by INRs will result in improved performance.

It will be appreciated that the methods disclosed herein are operable to create Neural Datasets of medical images that also include other data modes. For example, patient scans may well be accompanied by text in the form of clinician notes. These can be incorporated into the Neural dataset, and may assist with relevant downstream ML tasks such as segmentation. In organ segmentation, it may be desirable to represent each organ as a separate manifold, a possibility afforded by INRs owing to their ability to handle non-Euclidean manifolds.

As discussed above, the methods presented herein may be performed by a processing node, and the present disclosure provides a processing node that is adapted to perform any or all of the steps of the above discussed methods. The processing node may comprise a physical or virtual node, and may be implemented in a computer system, treatment apparatus, such as a radiotherapy treatment apparatus, computing device, or server apparatus, and/or may be implemented in a virtualized environment, for example in a cloud, edge cloud, or fog deployment. Examples of a virtual node may include a piece of software or computer program, a code fragment operable to implement a computer program, a virtualized function, or any other logical entity. The processing node may encompass multiple logical entities, as discussed in greater detail below.

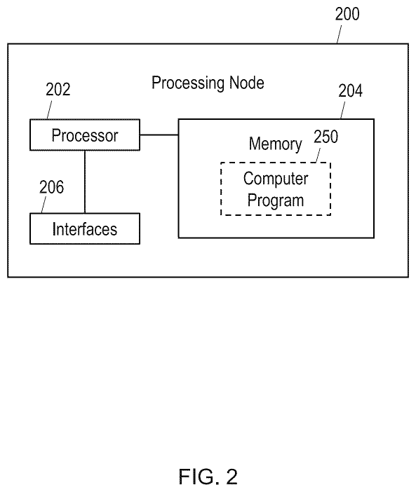

One example processing node that may implement the methods disclosed herein as discussed above, for example on receipt of suitable instructions from a computer program, is illustrated in FIG. 2. The example processing node 200 comprises a processor or processing circuitry 202, and may comprise a memory 204 and interfaces 206. The processing circuitry 202 is operable to perform some or all of the steps of the methods disclosed herein, for example as illustrated in FIG. 1 and discussed above.

The memory 204 may contain instructions executable by the processing circuitry 202 such that the example processing node 200 is operable to perform some or all of the steps of the methods disclosed herein. The instructions may also include instructions for executing one or more telecommunications and/or data communications protocols. The instructions may be stored in the form of the computer program 250. In some examples, the processor or processing circuitry 202 may include one or more microprocessors or microcontrollers, as well as other digital hardware, which may include digital signal processors (DSPs), special-purpose digital logic, etc. The processor or processing circuitry 202 may be implemented by any type of integrated circuit, such as an Application Specific Integrated Circuit (ASIC), Field Programmable Gate Array (FPGA) etc. The memory may include one or several types of memory suitable for the processor, such as read-only memory (ROM), random-access memory, cache memory, flash memory devices, optical storage devices, solid state disk, hard disk drive, etc.

In some examples as discussed above, the example processing node 200 may be incorporated into treatment apparatus, and examples of the present disclosure also provide a radiotherapy treatment apparatus comprising either or both of a processing node as discussed above and/or a planning node operable to implement a method for adapting a radiotherapy treatment plan.

The above discussion provides an overview of methods which may be performed according to different examples of the present disclosure. These methods may be performed by a processing node.

There now follows a detailed discussion of how different process steps illustrated in discussed above may be implemented. The functionality and implementation detail described below is discussed with reference to the modules of the processing nodes performing the methods substantially as described above.

The methods disclosed herein may for example be implemented using a code library, and the present disclosure also provides a discussion of such a library. The example implementation library disclosed herein is a JAX-based library for efficient and parallel training of implicit neural representations with a wide range of neural field architectures implemented. These architectures include SIREN, RFF and MFNs. The library also includes some downstream task methods. The library has been used to obtain and make publicly available a vast range of datasets that can be used as benchmarks for a variety of downstream tasks. These include CelebA, Imagenet 256×256, and ShapeNet. Benchmarking has been performed on the obtained Neural Datasets.

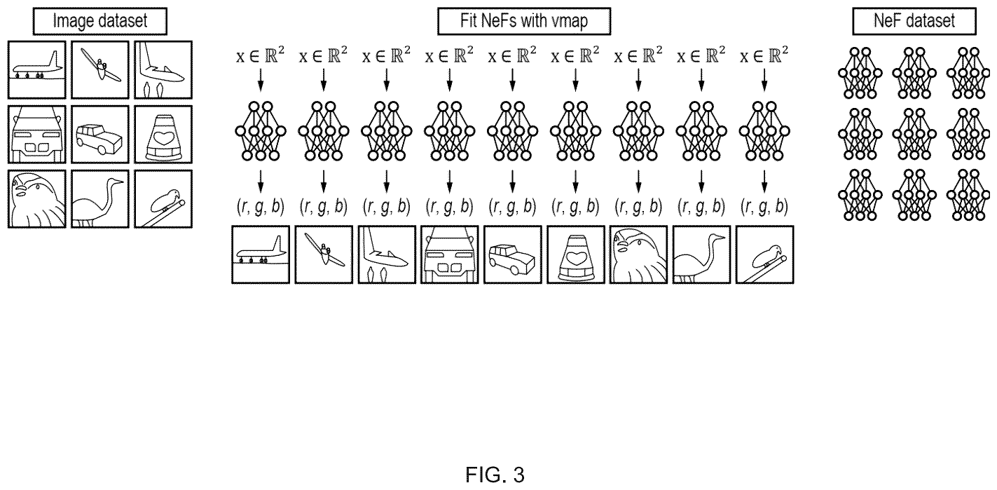

FIG. 3 illustrates an implementation framework for the methods of the present disclosure. The framework can be used to convert a dataset, for example a dataset of images, to a neural dataset (NeF dataset) using an efficient jax pipeline according to the example implementation code library. A range of widely carried datasets, including CIFAR10, CelebA, ShapeNet, were converted to their Neural variants using this pipeline, and ablation was carried out over a range of neural field hyperparameters, such as parameterization, network depth, network width, learning rate, weight decay, activation function, and/or initialization method.

The example code library is implemented in the jax framework, as it allows for simple parallelization of tiny networks across the GPU, as well as the just-in-time compilation provided natively by jax. The repository follows the “make it simple, not easy” philosophy, prioritizing extensibility, and strong independence between packages. The code library facilitates adding new tasks, new neural fields, and new datasets, and the dataset format is standardized across tasks.

The repository is structured as follows:
./config. Configuration files for the tasks.
./fast_fitting. Package for quickly fitting and storing neural fields. Here a user can add the trainer for their own task.
./nef. Package that provides the neural fields that are to be fitted. Here a user can add their own NeF.
./dataset. Package to load the targets and inputs used during training. Here a user can add their own dataset.
./tasks. Collection of the tasks that are to be carried out. Both fitting and downstream tasks fit here. Here a user can add the fitting scripts for their own tasks.
./tests. Tests for the code in the repository.
./assets. Contains the images used in a README file.

The basic usage of this repository is to fit neural fields to a collection of signals. The current signals supported are images and shapes (through occupancy).

Each task has its own fit.py file which is called to fit the neural fields to the provided signals. The fit.py file is optimized to provide maximum speed when fitting. Therefore, all logging options have been removed. NOTE: The repository will provide example scripts for tracking metrics and large-scale hyperparameter tuning in a future release. Considering a simple example, from the root folder can be run:

PYTHONPATH=“.” DATA_PATH=“./data/”python tasks/image/fit.py
task=config/image.py: fit
nef=config/nef.py: SIREN-task.train.seeds=0,1,2,3,4-task.train.start_idx=0
task.train.end_idx=120000-task.train.num_parallel_nefs=2000
task.dataset.name=“MNIST”
task.dataset.out_channels=1-task.dataset.path=“.”
task.nef_dir=“saved_models/example”

First, set PYTHONPATH=“.” to let Python find all the relevant packages (when we provide an install option, this won't be necessary). Then, set the DATA_PATH=“./data/” environment variable to indicate the root folder where all datasets are stored. For MNIST and CIFAR10 the dataset is downloaded in that folder automatically. Considering other options:
-task=config/image.py: fit: indicates which config file to use and that the task is to fit multiple nefs.
-nef=config/nef.py: SIREN: SIREN is selected as the neural field (nef). The nef.py config file contains a list of all nefs currently implemented.
-task.train.seeds=0,1,2,3,4: the seeds are to be used to initialize the models. These are used to augment the dataset with nefs that use new random initialization. Given that MNIST has 60k images, the total potential size of the neural dataset with 5 seeds will be 300k nefs.
-task.train.start_idx=0-task.train.end_idx=120000: with these values for start and end index, only the first 12k nefs out of 300k will be trained-this is consequently the “first” subset size and allows for parallelization of training across multiple devices or even nodes.
-task.train.num_parallel_nefs=2000: this variable ensures that 2k nefs will be fitted in parallel in the GPU. This is where the speed-up happens, the trainer will vmap across 2k nefs. This parameter is dependent on the GPU used, as the processing speed will saturate at a certain point.
-task.dataset.name=“MNIST”-task.dataset.out_channels=1-task.dataset.path=“.”: these define the dataset used.
-task.nef_dir=“saved_models/example”: this is the folder where the neural dataset is stored. If the folder does not exist, it gets created.

Example methods proposed according to the present disclosure therefore offer an efficient process for generating a Neural Dataset from a dataset of medical images, which Neural Dataset will be appropriate for use in a downstream ML task, and may be appropriate for use in a plurality of downstream ML tasks. The methods disclosed herein are particularly adapted to take advantage of processing apparatus offering the possibility of parallel processing, as well as to exploit opportunities for parallel processing across different processing apparatus. Examples of the methods disclosed herein generate Neural Datasets that are optimized for use in a downstream ML task.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A computer implemented method for generating a neural dataset of medical images, wherein the neural dataset is for use in a Machine Learning (ML) task, and wherein the neural dataset comprises a plurality of Implicit Neural Representations (INRs) each INR representing a medical image, the computer implemented method comprising:
obtaining: a dataset of medical images, a neural field, and a plurality of seeds for initiating the neural field;
obtaining a size of a first subset for the neural dataset, wherein the size is smaller than a total potential neural dataset, and wherein the total potential neural dataset comprises, for each medical image of the dataset of medical images, an INR generated from the neural field initiated with each of the plurality of seeds;
generating one or more additional INRs for the first subset by, for each INR of the first subset, fitting the neural field, initiated with one of the plurality of seeds, to a medical image in the dataset of medical images; and
outputting the INRs comprised in the first subset as the neural dataset, wherein generating the INRs for the first subset comprises generating a plurality of INRs of the first subset in parallel on a single processing apparatus.

2. The method as claimed in claim 1, wherein obtaining the neural field comprises obtaining a value for one or more hyperparameters describing a structure of the neural field and a training of the neural field.

3. The method as claimed in claim 2, wherein the one or more hyperparameters comprise one or more of: a parameterization, a network depth, a network width, a learning rate, a weight decay, an activation function, or an initialization method.

4. The method as claimed in claim 1, wherein the plurality of seeds for initiating the neural field comprise random initializations of one or more trainable parameters of the neural field.

5. The method as claimed in claim 1, wherein at least one of obtaining the dataset of medical images or obtaining the size of the first subset comprises receiving an input from a user.

6. The method as claimed in claim 1, wherein obtaining the size of the first subset for the neural dataset comprises obtaining index entries for a beginning and end of the first subset.

7. The method as claimed in claim 1, wherein, for each INR of the first subset, fitting the neural field, initiated with one of the plurality of seeds, to the medical image in the dataset of medical images comprises:
minimizing a loss function between an output of the neural field and the medical image in the dataset of medical images.

8. The method as claimed in claim 7, wherein the dataset of medical images comprise one or more two dimensional images, and wherein the loss function comprises a mean squared error loss.

9. The method as claimed in claim 7, wherein the dataset of medical images comprise one or more three dimensional images, and wherein the loss function comprises at least one of Mean Squared Error loss, Absolute Error loss, Cross Entropy loss, Binary Cross Entropy loss.

10. The method as claimed in claim 1, wherein the single processing apparatus comprises a Graphics Processing Unit (GPU).

11. The method as claimed in claim 1, further comprising:
obtaining a number of INRs of the first subset to be generated in parallel on the single processing apparatus.

12. The method as claimed in claim 1, further comprising:
generating INRs for one or more second subsets of the neural dataset by, for each INR of the one or more second subsets, fitting the neural field, initiated with one of the plurality of seeds, to a medical image in the dataset of medical images; and
outputting the INRs contained in the first subset and the INRs contained in the one or more second subsets as the neural dataset.

13. The method as claimed in claim 12, wherein generating the INRs for the one or more second subsets of the neural dataset comprises:
generating a plurality of INRs of the one or more second subsets in parallel on a single processing apparatus.

14. The method as claimed in claim 12, further comprising:
generating the INRs for the one or more second subsets and generating the INRs for the first subset in parallel across a plurality of processing apparatuses.

15. The method as claimed in claim 1, wherein the ML task comprises at least one of: a modeling task, a generative modeling task, a classification task, a regression task, a clustering task, an anomaly detection task, a segmentation task, or an object detection task.

16. The method as claimed in claim 1, wherein the neural dataset is for use in at least one of: i) training, testing, or validating an ML model for the ML task, or ii) inputting to an ML model that has been trained to perform the ML task.

17. The method as claimed in claim 1, further comprising:
generating a second neural dataset of the medical images by:
generating one or more INRs for a first subset of the second neural dataset, the first subset of the second neural dataset being of a same size as the first subset of the neural dataset; and
outputting the INRs comprised in the first subset of the second neural dataset as the second neural dataset;
wherein generating the one or more INRs for the first subset of the second neural dataset comprises:
for each INR of the first subset of the second neural dataset, fitting the neural field, initiated with one of the plurality of seeds, to a medical image in the second neural dataset; and
generating a plurality of INRs of the first subset of the second neural dataset in parallel on a single processing apparatus;
wherein a value of a hyperparameter of the neural field fitted to one or more medical images for the first subset of the second neural dataset is different than a value of that hyperparameter of the neural field fitted to one or more medical images of the first subset for the neural dataset.

18. The method as claimed in claim 1, further comprising:
using, as training data for an ML model, the generated neural dataset of medical images; and
inputting, to the ML model, the generated neural dataset of medical images.

19. A non-transitory computer-readable medium with instructions stored thereon, which when performed by a processor of a computing device, cause the computing device to:
obtain: a dataset of medical images, a neural field, and a plurality of seeds for initiating the neural field;
obtain a size of a first subset for the neural dataset, wherein the size is smaller than a total potential neural dataset, and wherein the total potential neural dataset comprises, for each medical image of the dataset of medical images, an Implicit Neural Representation (INR) generated from the neural field initiated with each of the plurality of seeds;
generate one or more additional INRs for the first subset by, for each INR of the first subset, fitting the neural field, initiated with one of the plurality of seeds, to a medical image in the dataset of medical images; and
output the INRs comprised in the first subset as the neural dataset, wherein generating INRs for the first subset comprises generating a plurality of INRs of the first subset in parallel on a single processing apparatus.

20. A processing node for generating a neural dataset of medical images, wherein the neural dataset is for use in a Machine Learning (ML) task, and wherein the neural dataset comprises a plurality of Implicit Neural Representations (INRs) each INR representing a medical image, the processing node comprising processing circuitry configured to cause the processing node to:
obtain: a dataset of medical images, a Neural Field, and a plurality of seeds for initiating the neural field;
obtain a size of a first subset for the neural dataset, wherein the size is smaller than a total potential neural dataset, and wherein the total potential neural dataset comprises, for each medical image of the dataset, an INR generated from the neural field initiated with each of the plurality of seeds;
generate one or more additional INRs for the first subset by, for each INR of the first subset, fitting the neural field, initiated with one of the plurality of seeds, to a medical image in the dataset; and
output the INRs comprised in the first subset as the Neural Dataset, wherein generating the INRs for the first subset comprises generating a plurality of INRs of the first subset in parallel on a single processing apparatus.

21. The processing node as claimed in claim 20, wherein the processing node is included in a radiotherapy treatment apparatus.
